(19) United States
(12) Patent Application Publication
(10) Pub. No.: US 2020/0342854 A1
(43) Pub. Date: Oct. 29, 2020

(54) METHOD AND APPARATUS FOR VOICE INTERACTION, INTELLIGENT ROBOT AND COMPUTER READABLE STORAGE MEDIUM

(71) Applicant: Beijing Baidu Netcom Science and Technology Co., Ltd., Beijing (CN)

(72) Inventor: Caiyu Li, Beijing (CN)

(21) Appl. No.: 16/709,554

(22) Filed: Dec. 10, 2019

(30) Foreign Application Priority Data
Apr. 24, 2019 (CN) 201910333028.X

(51) Int. Cl. G10L 15/07; G10L 15/26; B25J 11/00; G06F 3/16; G10L 15/22; G10L 15/02; G10L 25/03

(52) U.S. Cl. CPC G10L 15/07; G10L 15/26; B25J 11/0005; G10L 2015/223; G10L 15/22; G10L 15/02; G10L 25/03; G06F 3/167

(57) ABSTRACT

Embodiments of the present disclosure provide a method and apparatus for voice interaction, an intelligent robot, and a computer readable storage medium. The method is applied to an intelligent robot, and includes: obtaining object feature information of an interaction object in a voice interaction scenario; and performing voice interaction with the interaction object based on a voice broadcast parameter matching the object feature information.

### CROSS-REFERENCE TO RELATED APPLICATIONS

This application claims priority to Chinese Patent Application No. 201910333028.X, filed on Apr. 24, 2019, titled “Method and apparatus for voice interaction, intelligent robot, and computer readable storage medium,” which is hereby incorporated by reference in its entirety.

### TECHNICAL FIELD

Embodiments of the present disclosure relate to the field of robot technology, and specifically to a method and apparatus for voice interaction, an intelligent robot, and a computer readable storage medium.

### BACKGROUND

With the continuous improvement of the accuracy of speech recognition and semantic comprehension, the intelligent robot is increasingly favored by the market, and the intelligent robot is increasingly universally used.

When the intelligent robot serves a user, the intelligent robot will often perform voice interaction with the user. In general, in various circumstances, the intelligent robot uses a fixed voice interaction strategy, and then the intelligent robot uses a very single strategy during voice interaction, thus resulting in poor voice interaction effects.

### SUMMARY

Embodiments of the present disclosure provide a method and apparatus for voice interaction, an intelligent robot, and a computer readable storage medium, so as to solve the problem of poor voice interaction effects resulted by using a single strategy by the intelligent robot during voice interaction.

In order to solve the above problem, embodiments of the present disclosure are implemented as follows.

In a first aspect, an embodiment of the present disclosure provides a method for voice interaction, applied to an intelligent robot, the method including: obtaining object feature information of an interaction object in a voice interaction scenario; and performing voice interaction with the interaction object based on a voice broadcast parameter matching the object feature information.

In a second aspect, an embodiment of the present disclosure provides an apparatus for voice interaction, applied to an intelligent robot, the apparatus including: an obtaining module configured to obtain object feature information of an interaction object in a voice interaction scenario; and an interacting module configured to perform voice interaction with the interaction object based on a voice broadcast parameter matching the object feature information.

In a third aspect, an embodiment of the present disclosure provides an intelligent robot, comprising a processor, a memory, and a computer program stored on the memory and capable of running on the processor, where the computer program, when executed by the processor, implements the operations of the method for voice interaction.

In a fourth aspect, an embodiment of the present disclosure provides a computer readable storage medium, storing a computer program thereon, where the computer program, when executed by a processor, implements the operations of the method for voice interaction.

In embodiments of the present disclosure, in a voice interaction scenario, the intelligent robot may obtain object feature information of an interaction object, and perform voice interaction with the interaction object based on a voice broadcast parameter matching the object feature information. Thus, it can be seen that in the embodiments of the present disclosure, the intelligent robot may flexibly adjust the employed voice broadcast parameter based on actual situation of the interaction object, i.e., voice interaction strategies used by the intelligent robot are diversified and personalized. Thus, compared with the case of using a fixed voice interaction strategy in the related art, the intelligent robot in the embodiments of the present disclosure may provide more personalized services, and the voice interaction effect may be effectively improved.

### BRIEF DESCRIPTION OF THE DRAWINGS

To more clearly describe the technical solutions of the embodiments of the present disclosure, the accompanying drawings to be used in the description of embodiments of the present disclosure will be briefly introduced below. Apparently, the accompanying drawings described below are merely some embodiments of the present disclosure. For those of ordinary skills in the art, other drawings may also be acquired based on these drawings without making inventive efforts.

FIG. 1 is a first one of flowcharts of a method for voice interaction provided in an embodiment of the present disclosure;

FIG. 2 is a second one of flowcharts of the method for voice interaction provided in an embodiment of the present disclosure;

FIG. 3 is a third one of flowcharts of the method for voice interaction provided in an embodiment of the present disclosure;

FIG. 4 is a fourth one of flowcharts of the method for voice interaction provided in an embodiment of the present disclosure;

FIG. 5 is a structural block diagram of an apparatus for voice interaction provided in an embodiment of the present disclosure; and

FIG. 6 is a schematic structural diagram of an intelligent robot provided in an embodiment of the present disclosure.

### DETAILED DESCRIPTION OF EMBODIMENTS

The technical solutions of the embodiments of the present disclosure will be clearly and completely described below in conjunction with the accompanying drawings in embodiments of the present disclosure. Apparently, the embodiments described below are a part, instead of all, of the embodiments of the present disclosure. All other embodiments acquired by those of ordinary skills in the art based on the embodiments of the present disclosure without making inventive efforts fall within the scope of protection of the present disclosure.

Referring to FIG. 1, a first one of flowcharts of a method for voice interaction provided in an embodiment of the present disclosure is shown. As shown in FIG. 1, the method is applied to an intelligent robot, and includes the following steps.

Step 101: obtaining object feature information of an interaction object in a voice interaction scenario.

Here, the interaction object may also be referred to as a service object of the intelligent robot.

Alternatively, the object feature information may include at least one of the following items: an object voice output parameter, an object emotion, or an object attribute.

The object voice output parameter includes at least one of an object speech rate, an object volume, or an object timbre, and the object attribute includes at least one of an object age attribute, an object gender attribute, or an object skin color attribute.

Here, the object age attribute may include a child attribute, a youth attribute, a middle age attribute, an old age attribute, and the like; the object gender attribute may include a male attribute, a female attribute, and the like; and the object skin color attribute may include a yellow skin attribute, a white skin attribute, a black skin attribute, and the like.

Step 102: performing voice interaction with the interaction object based on a voice broadcast parameter matching the object feature information.

Here, the voice broadcast parameter includes, but is not limited to, a voice broadcast speed, a voice broadcast volume, a voice broadcast timbre, and the like.

After obtaining the object feature information of the interaction object, the intelligent robot may determine a voice broadcast parameter matching the obtained object feature information; where a voice broadcast parameter matching any piece of object feature information refers to: a voice broadcast parameter that may bring better interactive experience to an object with the object feature information. Thus, in the case where the intelligent robot performs voice interaction with the interaction object based on the determined voice broadcast parameter, the interactive experience of the interaction object may be guaranteed, and accordingly, the voice interaction effect may be guaranteed too.

In an embodiment of the present disclosure, in the voice interaction scenario, the intelligent robot may obtain the object feature information of the interaction object, and perform voice interaction with the interaction object based on the voice broadcast parameter matching the object feature information. Thus, it can be seen that in some embodiments of the present disclosure, the intelligent robot may flexibly adjust the employed voice broadcast parameter based on actual situation of the interaction object, i.e., voice interaction policies used by the intelligent robot are diversified and personalized. Thus, compared with the case of using a fixed voice interaction policy in the prior art, the intelligent robot in the embodiments of the present disclosure may provide more personalized services, and the voice interaction effect may be effectively improved.

Alternatively, the obtaining object feature information of an interaction object includes: statisticizing the number of voice output words of the interaction object in a target duration, and computing the object speech rate of the interaction object based on the target duration and the number of voice output words.

Here, the target duration may be a defined time length; or, the target duration may be a time length randomly determined by the intelligent robot. Specifically, the target duration may be 1 minute, 2 minutes, 5 minutes, or other time length, which will not be enumerated here.

Specifically, after statisticizing the number of voice output words of the interaction object in the target duration (e.g., 2 minutes), the number of voice output words of the interaction object within a unit time may be computed based on the target duration and the statisticized number of voice output words. For example, the statisticized number of voice output words may be divided by 2 minutes, to obtain the number of voice output words of the interaction object within 1 minute. Then, the intelligent robot may use the number of voice output words of the interaction object within the unit time as the object speech rate of the interaction object.

Thus, it can be seen that it is very convenient to implement obtaining the object speech rate of the interaction object.

Alternatively, the intelligent robot includes a camera.

The obtaining object feature information of an interaction object includes: invoking the camera to capture a face image of the interaction object, and obtaining the object emotion of the interaction object based on the face image.

Here, the camera included in the intelligent robot specifically may be a front camera.

Specifically, after invoking the camera to capture the face image of the interaction object, the intelligent robot may analyze the captured face image to determine whether a facial feature, such as frowning, facial tension, or tense expression, in the face image is capable of reflecting an anxious emotion. In the case of determining the facial feature in the face image being capable of reflecting the anxious emotion, the intelligent robot may determine that the object emotion of the interaction object is the anxious emotion; and in the case of determining that no facial feature in the face image being capable of reflecting the anxious emotion, the intelligent robot may determine that the object emotion of the interaction object is a non-anxious emotion.

It should be noted that the object attribute may also be obtained by analyzing the face image captured by invoking the camera.

Thus, it can be seen that it is very convenient to implement the obtaining the object emotion of the interaction object.

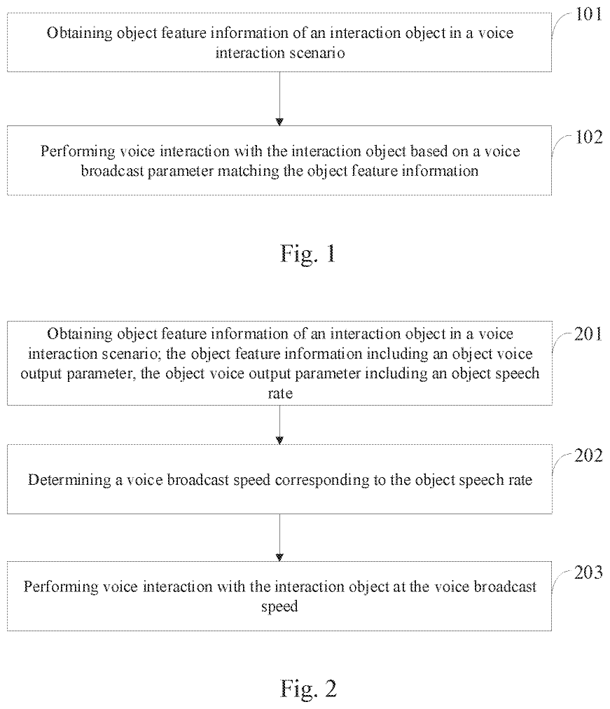

Referring to FIG. 2, a second one of flowcharts of the method for voice interaction provided in an embodiment of the present disclosure is shown. As shown in FIG. 2, the method is applied to an intelligent robot, and includes the following steps.

Step 201: obtaining object feature information of an interaction object in a voice interaction scenario; the object feature information including an object voice output parameter, the object voice output parameter including an object speech rate.

Here, the interaction object may also be referred to as a service object of the intelligent robot.

It should be noted that the object voice output parameter may include not only the object speech rate, but also at least one of an object volume or an object timbre; and the object feature information may include not only the object voice output parameter, but also at least one of an object emotion or an object attribute. The object attribute may include at least one of an object age attribute, an object gender attribute, or an object skin color attribute.

Step 202: determining a voice broadcast speed corresponding to the object speech rate.

Step 203: performing voice interaction with the interaction object at the voice broadcast speed.

Here, the intelligent robot may pre-store a corresponding relationship between an object speech rate range and the voice broadcast speed (subsequently referred to as a first corresponding relationship, to distinguish from a corresponding relationship arising hereinafter); where a voice broadcast speed corresponding to any object speech rate range is very close to an object speech rate within the object speech rate range.

It should be noted that since the object feature information of the interaction object includes the object speech rate, the intelligent robot may first obtain an object speech rate range of the object speech rate in the object feature information; then the intelligent robot may determine a voice broadcast speed corresponding to the obtained object speech rate range based on the first corresponding relationship; and finally, the intelligent robot may perform voice interaction with the interaction object at the determined voice broadcast speed.

Specifically, assuming that the intelligent robot in some embodiments of the present disclosure is a consulting service robot in an airport, and when the intelligent robot provides a counseling service for a user, if the user ask questions in a normal speech rate, the intelligent robot may answer the user's questions at a normal voice broadcast speed; if the user ask questions at a fast speech rate, the intelligent robot may answer the user's questions at a fast voice broadcast speed; and if the user ask questions at a slow speech rate, the intelligent robot may answer the user's questions at a slow voice broadcast speed.

It should be noted that the intelligent robot may alternatively not pre-store the first corresponding relationship, and may directly use the object speech rate itself as the corresponding voice broadcast speed when determining the voice broadcast speed corresponding to the object speech rate, which is also feasible.

In some embodiments of the present disclosure, in the voice interaction scenario, the intelligent robot may obtain the object feature information of the interaction object, and perform voice interaction with the interaction object based on the voice broadcast speed corresponding to the object speech rate in the object feature information. Thus, it can be seen that in some embodiments of the present disclosure, the intelligent robot may flexibly adjust the employed voice broadcast speed based on the object speech rate of the interaction object. In the case where the object speech rate of the interaction object is fast, the voice broadcast speed of the intelligent robot will be fast, while in the case where the object speech rate of the interaction object is slow, the voice broadcast speed of the intelligent robot will be slow, thus preventing a fixed voice broadcast speed from resulting in maladaptation for the interaction object, thereby enhancing the interactive experience of the interaction object, and improving the voice interaction effect.

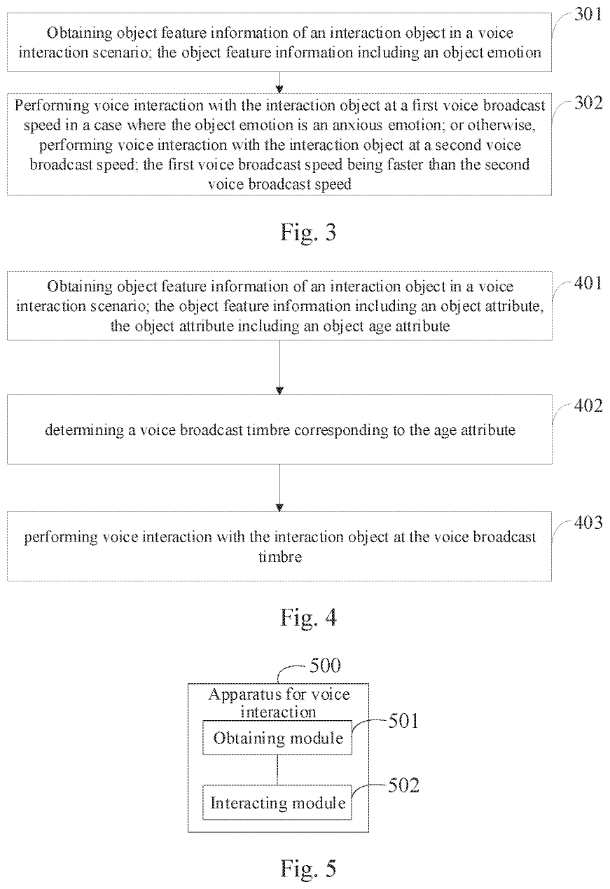

Referring to FIG. 3, a third one of flowcharts of the method for voice interaction provided in an embodiment of the present disclosure is shown. As shown in FIG. 3, the method is applied to an intelligent robot, and includes the following steps.

Step 301: obtaining object feature information of an interaction object in a voice interaction scenario; the object feature information including an object emotion.

Here, the interaction object may also be referred to as a service object of the intelligent robot.

It should be noted that the object feature information includes an object emotion, and may further include at least one of an object voice output parameter or an object attribute. The object voice output parameter includes at least one of an object speech rate, an object volume, or an object timbre, and the object attribute includes at least one of an object age attribute, an object gender attribute, or an object skin color attribute.

Step 302: performing voice interaction with the interaction object at a first voice broadcast speed in a case where the object emotion is an anxious emotion; or otherwise, performing voice interaction with the interaction object at a second voice broadcast speed; the first voice broadcast speed being faster than the second voice broadcast speed.

Here, the intelligent robot may pre-store a second corresponding relationship. In the second corresponding relationship, the anxious emotion corresponds to the first voice broadcast speed, a non-anxious emotion corresponds to the second voice broadcast speed, and the first voice broadcast speed is faster than the second voice broadcast speed.

It should be noted that since the object feature information of the interaction object includes the object emotion, the intelligent robot may determine whether the object emotion in the object feature information is the anxious emotion. No matter whether the object emotion in the object feature information is the anxious emotion or not, based on the second corresponding relationship, the intelligent robot may determine the voice broadcast speed corresponding to the object emotion in the object feature information, and then the intelligent robot may perform voice interaction with the interaction object at the determined voice broadcast speed.

Specifically, assuming that the intelligent robot in some embodiments of the present disclosure is a consulting service robot in an airport, and when the intelligent robot provides a counseling service for a user, if the user is anxious to go aboard, but cannot find out a boarding gate, the user will show an anxious emotion. In this case, the intelligent robot will answer the user's questions at a fast voice broadcast speed, such that the user fast finds out the boarding gate.

It should be noted that the intelligent robot may alternatively not pre-store the second corresponding relationship. The intelligent robot may alternatively determine the voice broadcast speed corresponding the object emotion by other approaches, as long as the voice broadcast speed of the intelligent robot when the interaction object is in the anxious emotion is guaranteed to be faster than the voice broadcast speed of the intelligent robot when the interaction object is in the non-anxious emotion.

In some embodiments of the present disclosure, in the voice interaction scenario, the intelligent robot may obtain the object feature information of the interaction object, and perform voice interaction with the interaction object based on the voice broadcast speed corresponding to the object emotion in the object feature information. Thus, it can be seen that in some embodiments of the present disclosure, the intelligent robot may flexibly adjust the employed voice broadcast speed based on the object emotion of the interaction object. In the case where the object emotion of the interaction object is the anxious emotion, the voice broadcast speed of the intelligent robot will be fast, while in the case where the object emotion of the interaction object is the non-anxious emotion, the voice broadcast speed of the intelligent robot will be slow, thus preventing a fixed voice broadcast speed from bringing inconveniences to the interaction object, thereby enhancing the interactive experience of the interaction object, and improving the voice interaction effect.

Referring to FIG. 4, a fourth one of flowcharts of the method for voice interaction provided in an embodiment of the present disclosure is shown. As shown in FIG. 4, the method is applied to an intelligent robot, and includes the following steps.

Step 401: obtaining object feature information of an interaction object in a voice interaction scenario; the object feature information including an object attribute, the object attribute including an object age attribute.

Here, the interaction object may also be referred to as a service object of the intelligent robot.

It should be noted that the object attribute may include not only the object age attribute, but also at least one of an object gender attribute or an object skin color attribute; and the object feature information may include not only the object attribute, but also at least one of an object voice output parameter or an object emotion. The object voice output parameter includes at least one of an object speech rate, an object volume, or an object timbre.

Step 402: determining a voice broadcast timbre corresponding to the age attribute.

Step 403: performing voice interaction with the interaction object at the voice broadcast timbre.

Here, the intelligent robot may pre-store a corresponding relationship between the age attribute and the voice broadcast timbre (subsequently referred to as a third corresponding relationship, to distinguish from the corresponding relationship arising above). Specifically, in the third corresponding relationship, a voice broadcast timbre corresponding to a child attribute may be a tender and lovely timbre of a child, a voice broadcast timbre corresponding to a middle age attribute may be a vigorous and mature timbre of a middle aged person, and a voice broadcast timbre corresponding to an old age attribute may be a calm and warm timbre of an old person. Thus, in the case where the object feature information of the interaction object includes the age attribute, the intelligent robot may determine the voice broadcast timbre corresponding to the age attribute in the object feature information based on the third corresponding relationship, and perform voice interaction with the interaction object based on the determined voice broadcast timbre.

Specifically, assuming that the intelligent robot in some embodiments of the present disclosure is a consulting service robot in an airport, and when the intelligent robot provides a counseling service for a user, if the user asking questions is a child, the intelligent robot will answer the user's questions at the tender and lovely timbre; if the user asking questions is a middle-aged person, the intelligent robot will answer the user's questions at the vigorous and mature timbre; and if the user asking questions is an old person, the intelligent robot will answer the user's questions at the calm and warm timbre.

In some embodiments of the present disclosure, in the voice interaction scenario, the intelligent robot may obtain the object feature information of the interaction object, and perform voice interaction with the interaction object based on the voice broadcast timbre corresponding to the object age attribute in the object feature information. Thus it can be seen that in some embodiments of the present disclosure, the intelligent robot may flexibly adjust the employed voice broadcast timbre based on the object age attribute of the interaction object, to increase the interestingness of the interaction process, thereby enhancing the interactive experience of the interaction object, and improving the voice interaction effect.

In summary, compared with the related art, in some embodiments of the present disclosure, the intelligent robot can provide more personalized services, such that the voice interaction effects may be effectively enhanced.

Referring to FIG. 5, a structural block diagram of an apparatus 500 for voice interaction provided in an embodiment of the present disclosure is shown. As shown in FIG. 5, the apparatus 500 for voice interaction includes: an obtaining module 501 configured to obtain object feature information of an interaction object in a voice interaction scenario; and an interacting module 502 configured to perform voice interaction with the interaction object based on a voice broadcast parameter matching the object feature information.

Alternatively, the object feature information includes at least one of the following items: an object voice output parameter, an object emotion, or an object attribute.

The object voice output parameter includes at least one of an object speech rate, an object volume, or an object timbre, and the object attribute includes at least one of an object age attribute, an object gender attribute, or an object skin color attribute.

Alternatively, the object feature information includes the object voice output parameter, and the object voice output parameter includes the object speech rate.

The interacting module 502 includes: a first determining unit configured to determine a voice broadcast speed corresponding to the object speech rate; and a first interacting unit configured to perform voice interaction with the interaction object at the voice broadcast speed.

Alternatively, the object feature information includes an object emotion.

The interacting module 502 is specifically configured to: perform voice interaction with the interaction object at a first voice broadcast speed in a case where the object emotion is an anxious emotion; or otherwise, perform voice interaction with the interaction object at a second voice broadcast speed.

The first voice broadcast speed is faster than the second voice broadcast speed.

Alternatively, the object feature information includes the object attribute, and the object attribute includes the object age attribute.

The interacting module 502 includes: a second determining unit configured to determine a voice broadcast timbre corresponding to the age attribute; and a second interacting unit configured to perform voice interaction with the interaction object at the voice broadcast timbre.

Alternatively, the obtaining module 501 is specifically configured to: statisticize the number of voice output words of the interaction object in a target duration, and compute the object speech rate of the interaction object based on the target duration and the number of voice output words.

Alternatively, the intelligent robot includes a camera.

The obtaining module 501 is specifically configured to: invoke the camera to capture a face image of the interaction object, and obtain the object emotion of the interaction object based on the face image.

In some embodiments of the present disclosure, in the voice interaction scenario, the intelligent robot may obtain the object feature information of the interaction object, and perform voice interaction with the interaction object based on the voice broadcast parameter matching the object feature information. Thus, it can be seen that in some embodiments of the present disclosure, the intelligent robot may flexibly adjust the employed voice broadcast parameter based on actual situation of the interaction object, i.e., voice interaction strategies used by the intelligent robot are diversified and personalized. Thus, compared with the case of using a fixed voice interaction strategy in the related art, the intelligent robot in the embodiments of the present disclosure may provide more personalized services, and the voice interaction effect can be effectively improved.

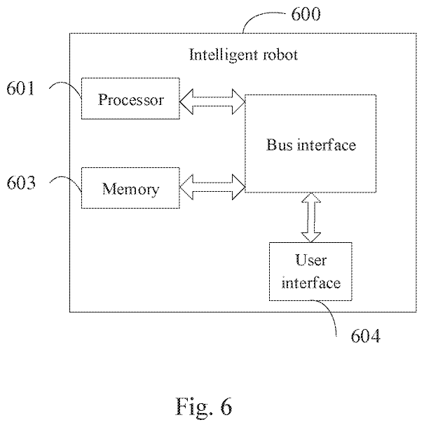

Referring to FIG. 6, a schematic structural diagram of an intelligent robot 600 provided in an embodiment of the present disclosure is shown. As shown in FIG. 6, the intelligent robot 600 includes: a processor 601, a memory 603, a user interface 604, and a bus interface.

The processor 601 is configured to read a program in the memory 603, and execute the following operations: obtaining object feature information of an interaction object in a voice interaction scenario; and performing voice interaction with the interaction object based on a voice broadcast parameter matching the object feature information.

In FIG. 6, a bus architecture may include any number of interconnecting buses and bridges, and is specifically linked by various circuits of one or more processors represented by the processor 601 and a memory represented by the memory 603. The bus architecture may further link various other circuits, such as peripherals, voltage stabilizers, and power management circuits, which are well known to the art, and therefore will not be further described herein. The bus interface provides an interface. For different user devices, the user interface 604 may further be an interface capable of connecting to a desired device externally or internally. The connected device includes, but is not limited to, a keypad, a displayer, a speaker, a microphone, a joystick, and the like.

The processor 601 is responsible for managing the bus architecture and usual processing. The memory 603 may store data used by the processor 601 when performing operations.

Alternatively, the object feature information includes at least one of the following items: an object voice output parameter, an object emotion, or an object attribute.

The object voice output parameter includes at least one of an object speech rate, an object volume, or an object timbre, and the object attribute includes at least one of an object age attribute, an object gender attribute, or an object skin color attribute.

Alternatively, the object feature information includes the object voice output parameter, and the object voice output parameter includes the object speech rate.

The processor 601 is specifically configured to: determine a voice broadcast speed corresponding to the object speech rate; and perform voice interaction with the interaction object at the voice broadcast speed.

Alternatively, the object feature information includes an object emotion.

The processor 601 is specifically configured to: perform voice interaction with the interaction object at a first voice broadcast speed in a case where the object emotion is an anxious emotion; or otherwise, perform voice interaction with the interaction object at a second voice broadcast speed.

The first voice broadcast speed is faster than the second voice broadcast speed.

Alternatively, the object feature information includes the object attribute, and the object attribute includes the object age attribute.

The processor 601 is specifically configured to: determine a voice broadcast timbre corresponding to the age attribute; and perform voice interaction with the interaction object at the voice broadcast timbre.

Alternatively, the processor 601 is specifically configured to: statisticize the number of voice output words of the interaction object in a target duration, and compute the object speech rate of the interaction object based on the target duration and the number of voice output words.

Alternatively, the intelligent robot includes a camera.

The processor 601 is specifically configured to: invoke the camera to capture a face image of the interaction object, and obtain the object emotion of the interaction object based on the face image.

In some embodiments of the present disclosure, in the voice interaction scenario, the intelligent robot 600 may obtain the object feature information of the interaction object, and perform voice interaction with the interaction object based on the voice broadcast parameter matching the object feature information. Thus it can be seen that in some embodiments of the present disclosure, the intelligent robot 600 may flexibly adjust the employed voice broadcast parameter based on actual situation of the interaction object, i.e., voice interaction strategies used by the intelligent robot 600 are diversified and personalized. Thus, compared with the case of using a fixed voice interaction strategy in the related art, the intelligent robot 600 in the embodiments of the present disclosure may provide more personalized services, and the voice interaction effect may be effectively improved.

Preferably, an embodiment of the present disclosure further provides an intelligent robot, including a processor 601, a memory 603, and a computer program stored on the memory 603 and capable of running on the processor 601. The computer program, when executed by the processor 601, implements each operation of the method for voice interaction of the above embodiments, and may achieve the same technical effects. To avoid repetition, the description will not be repeated here.

An embodiment of the present disclosure further provides a computer readable storage medium, storing a computer program thereon, where the computer program, when executed by a processor, implements each operation of the method for voice interaction of the above embodiments, and may achieve the same technical effects. To avoid repetition, the description will not be repeated here. The computer readable storage medium may include, e.g., a read-only memory (ROM for short), a random access memory (RAM for short), a diskette, or an optical disk.

While the embodiments of the present disclosure have been described above in conjunction with the accompanying drawings, the present disclosure is not limited to the specific embodiments described above, the above specific embodiments are merely illustrative and non-limiting. Enlightened by the present disclosure, those of ordinary skills in the art may further make many forms without departing from the objective of the present disclosure and the scope of protection of the appended claims. All these forms fall within the scope of protection of the present disclosure.

What is claimed is:

1. A method for voice interaction, applied to an intelligent robot, the method comprising:
obtaining object feature information of an interaction object in a voice interaction scenario; and
performing voice interaction with the interaction object based on a voice broadcast parameter matching the object feature information.

2. The method according to claim 1, wherein the object feature information comprises at least one of following items:
an object voice output parameter, an object emotion, or an object attribute;
wherein the object voice output parameter comprises at least one of: an object speech rate, an object volume, or an object timbre, and the object attribute comprises at least one of: an object age attribute, an object gender attribute, or an object skin color attribute.

3. The method according to claim 2, wherein the object feature information comprises the object voice output parameter, and the object voice output parameter comprises the object speech rate; and
the performing voice interaction with the interaction object based on a voice broadcast parameter matching the object feature information comprises:
determining a voice broadcast speed corresponding to the object speech rate; and
performing voice interaction with the interaction object at the voice broadcast speed.

4. The method according to claim 2, wherein the object feature information comprises the object emotion; and
the performing voice interaction with the interaction object based on a voice broadcast parameter matching the object feature information comprises:
performing voice interaction with the interaction object at a first voice broadcast speed in a case where the object emotion is an anxious emotion; or otherwise, performing voice interaction with the interaction object at a second voice broadcast speed;
wherein the first voice broadcast speed is faster than the second voice broadcast speed.

5. The method according to claim 2, wherein the object feature information comprises the object attribute, and the object attribute comprises the object age attribute; and
the performing voice interaction with the interaction object based on a voice broadcast parameter matching the object feature information comprises:
determining a voice broadcast timbre corresponding to the age attribute; and
performing voice interaction with the interaction object at the voice broadcast timbre.

6. The method according to claim 2, wherein
the obtaining object feature information of an interaction object comprises:
statisticizing a number of voice output words of the interaction object in a target duration, and computing the object speech rate of the interaction object based on the target duration and the number of voice output words;
and/or,
the intelligent robot comprises a camera; and
the obtaining object feature information of an interaction object comprises:
invoking the camera to capture a face image of the interaction object, and obtaining the object emotion of the interaction object based on the face image.

7. An apparatus for voice interaction, applied to an intelligent robot, the apparatus comprising:
at least one processor; and
a memory storing instructions, wherein the instructions when executed by the at least one processor, cause the at least one processor to perform operations, the operations comprising:
obtaining object feature information of an interaction object in a voice interaction scenario; and
performing voice interaction with the interaction object based on a voice broadcast parameter matching the object feature information.

8. The apparatus according to claim 7, wherein the object feature information comprises at least one of following items:
an object voice output parameter, an object emotion, or an object attribute;
wherein the object voice output parameter comprises at least one of: an object speech rate, an object volume, or an object timbre, and the object attribute comprises at least one of an object age attribute, an object gender attribute, or an object skin color attribute.

9. The apparatus according to claim 8, wherein the object feature information comprises the object voice output parameter, and the object voice output parameter comprises the object speech rate; and
the performing voice interaction with the interaction object based on a voice broadcast parameter matching the object feature information comprises:
determining a voice broadcast speed corresponding to the object speech rate; and
performing voice interaction with the interaction object at the voice broadcast speed.

10. The apparatus according to claim 8, wherein the object feature information comprises the object emotion; and
the performing voice interaction with the interaction object based on a voice broadcast parameter matching the object feature information comprises:
performing voice interaction with the interaction object at a first voice broadcast speed in a case where the object emotion is an anxious emotion; or otherwise, performing voice interaction with the interaction object at a second voice broadcast speed;
wherein the first voice broadcast speed is faster than the second voice broadcast speed.

11. The apparatus according to claim 8, wherein the object feature information comprises the object attribute, and the object attribute comprises the object age attribute; and
the performing voice interaction with the interaction object based on a voice broadcast parameter matching the object feature information comprises:
determining a voice broadcast timbre corresponding to the age attribute; and
performing voice interaction with the interaction object at the voice broadcast timbre.

12. The apparatus according to claim 8, wherein
the obtaining object feature information of an interaction object comprises:
statisticizing a number of voice output words of the interaction object in a target duration, and computing the object speech rate of the interaction object based on the target duration and the number of voice output words;
and/or,
the intelligent robot comprises a camera; and
the obtaining object feature information of an interaction object comprises:
invoking the camera to capture a face image of the interaction object, and obtaining the object emotion of the interaction object based on the face image.

13. An intelligent robot, comprising a processor, a memory, and a computer program stored on the memory and capable of running on the processor, wherein the computer program, when executed by the processor, implements the method for voice interaction according to claim 1.

14. A non-transitory computer readable storage medium, storing a computer program thereon, wherein the computer program, when executed by a processor, causes the processor to perform operations, the operations comprising:
obtaining object feature information of an interaction object in a voice interaction scenario; and
performing voice interaction with the interaction object based on a voice broadcast parameter matching the object feature information.

15. The non-transitory computer readable storage medium according to claim 14, wherein the object feature information comprises at least one of following items:
an object voice output parameter, an object emotion, or an object attribute;
wherein the object voice output parameter comprises at least one of: an object speech rate, an object volume, or an object timbre, and the object attribute comprises at least one of an object age attribute, an object gender attribute, or an object skin color attribute.

16. The non-transitory computer readable storage medium according to claim 15, wherein the object feature information comprises the object voice output parameter, and the object voice output parameter comprises the object speech rate; and
the performing voice interaction with the interaction object based on a voice broadcast parameter matching the object feature information comprises:
determining a voice broadcast speed corresponding to the object speech rate; and
performing voice interaction with the interaction object at the voice broadcast speed.

17. The non-transitory computer readable storage medium according to claim 15, wherein the object feature information comprises the object emotion; and
the performing voice interaction with the interaction object based on a voice broadcast parameter matching the object feature information comprises:
performing voice interaction with the interaction object at a first voice broadcast speed in a case where the object emotion is an anxious emotion; or otherwise, performing voice interaction with the interaction object at a second voice broadcast speed;
wherein the first voice broadcast speed is faster than the second voice broadcast speed.

18. The non-transitory computer readable storage medium according to claim 15, wherein the object feature information comprises the object attribute, and the object attribute comprises the object age attribute; and
the performing voice interaction with the interaction object based on a voice broadcast parameter matching the object feature information comprises:
determining a voice broadcast timbre corresponding to the age attribute; and
performing voice interaction with the interaction object at the voice broadcast timbre.

19. The non-transitory computer readable storage medium according to claim 15, wherein
the obtaining object feature information of an interaction object comprises:
statisticizing a number of voice output words of the interaction object in a target duration, and computing the object speech rate of the interaction object based on the target duration and the number of voice output words;
and/or,
the intelligent robot comprises a camera; and
the obtaining object feature information of an interaction object comprises:
invoking the camera to capture a face image of the interaction object, and obtaining the object emotion of the interaction object based on the face image.
